(19) United States
(12) Patent Application Publication
(10) Pub. No.: US 2014/0218695 A1
(43) Pub. Date: Aug. 7, 2014

(54) ORTHOGONALLY DISPOSED PROJECTION SURFACES

(71) Applicant: 3M INNOVATIVE PROPERTIES COMPANY, St. Paul, MN (US)

(72) Inventors: Ralph R. Roberts, Cottage Grove, MN (US); Glenn E. Casner, Woodbury, MN (US); Brett J. Sitter, Duluth, MN (US); Robert W. Shannon, Roseville, MN (US)

(73) Assignee: 3M INNOVATIVE PROPERTIES COMPANY, St. Paul, MN (US)

(21) Appl. No.: 13/756,782

(22) Filed: Feb. 1, 2013

(51) Int. Cl. G03B 21/14

(52) U.S. Cl. CPC G03B 21/14
USPC 353/69; 353/121

(57) ABSTRACT

A system for projecting changeable electronic content across multiple display surfaces. The system includes display surfaces arranged at a non-zero angle with respect to one another, such as three orthogonal display surfaces in the corner of a rectangular shaped product container. Changeable electronic content, including video and digital still images, is converted such that, when the projector receives and projects the content to the multiple display surfaces, the content is displayed undistorted to a viewer.

### BACKGROUND

Consumers have become inundated with static image content at the point of purchase. The static image content typically promotes or provides information about products in an attempt to influence consumers' purchasing decisions. However, determining the effectiveness of such static image content can be difficult. There is thus a need for new ways to attract the attention of consumers in providing them with advertisements or other product promotional content. One approach involves converting these static surfaces to video surfaces and providing video content for advertisements, attempting to attract consumers' attention through an active type of content. This video content is typically provided on flat screen display devices, such as liquid crystal display devices, proximate or near the product being promoted. The effectiveness of this type of advertisement may be limited when the consumers are simply viewing potential products to purchase and not viewing the display. Accordingly, there is a need for a new way to delivery video content, particular on surfaces that may resemble actual product containers.

### SUMMARY

A system for projecting changeable electronic content onto multiple display surfaces, consistent with the present invention, includes first and second display surfaces and a projector located for projecting electronic content to the display surfaces. The first and second display surfaces are arranged at a non-zero angle with respect to one another. When the projector receives converted electronic content and projects the converted electronic content to the first and second display surfaces, those surfaces display the converted electronic content undistorted to a viewer.

A method for projecting changeable electronic content onto multiple display surfaces, consistent with the present invention, includes providing a plurality of display surfaces arranged at a non-zero angle with respect to one another and receiving changeable electronic content. The content is converted for display on the plurality of display surfaces, and the converted content is projected and displayed on those display surfaces such that the converted content appears undistorted to a viewer.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a projection system for providing changeable electronic content onto orthogonal display surfaces;

FIG. 2 is a flow chart of a method for providing changeable electronic content onto orthogonal display surfaces;

FIG. 3 is a diagram illustrating ray tracing to show ray intersections onto three orthogonal display surfaces for use in converting content for display;

FIG. 4 is a diagram of a projection system for providing changeable electronic content onto orthogonal display surfaces for a dual view display;

FIG. 5 is a diagram illustrating an example of projecting electronic content onto orthogonal display surfaces; and

FIG. 6 is a diagram illustrating a template mask for content optimization for the Examples.

### DETAILED DESCRIPTION

Embodiments of the present invention include display systems having two or more display surfaces of varied orientation in space. The display surfaces can be orthogonal to one another and can have edges in physical contact or adjacent one another. In one embodiment, the display surfaces are three orthogonal planes that meet to form a corner display, for example the corner of a rectangular shaped product container or housing. The display system can also be modified for viewing from one or more perspectives to provide a dual view display.

A system for projecting content onto non-planar display surfaces is disclosed in U.S. Patent Application Publication No. 2012/0327297, which is incorporated herein by reference as if fully set forth. A system for projecting content on multiple display surfaces is disclosed in U.S. patent application Ser. No. 13/195,965, filed Aug. 2, 2011, and entitled “Display System and Method for Projection onto Multiple Surfaces,” which is incorporated herein by reference as if fully set forth. Rear projection screens, including shaped screens, are described in U.S. Pat. Nos. 7,923,675 and 6,870,670, both of which are incorporated herein by reference as if fully set forth.

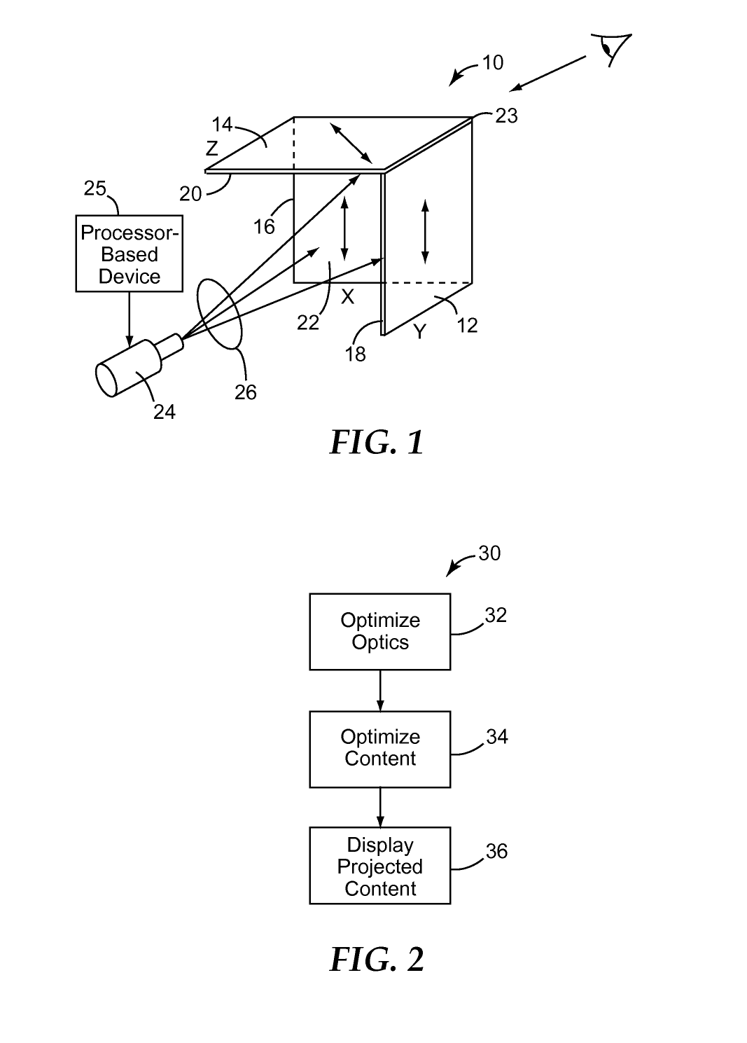

FIG. 1 is a diagram of a projection system 10 for providing changeable electronic content onto orthogonal display surfaces. System 10 includes display surfaces 12, 14, and 16, each composed of a rear projection screen with light redirecting films (or turning films) 18, 20, and 22, respectively, behind them on a non-viewer side of the display surfaces. The arrows on display surfaces 12, 14, and 16 represent the direction of the prisms in the light redirecting films behind those display surfaces. System 10 includes a projector 24 for projecting changeable electronic content to display surfaces 12, 14 and 16, as represented by lines 26, and a processor-based device 25 for electronically providing content to projector 24. The changeable electronic content can include electronic video content and changeable electronic still images. The electronic content is predistorted or otherwise converted such that, when displayed on display surfaces 12, 14, and 16, the content appears substantially undistorted to a viewer as shown positioned along a line between projector 24 and a point 23 where the three display surfaces come together.

System 10 is shown as transforming the corner of a cube-like container or housing into a multi-surface display for illustrative purposes. Other configurations of display surfaces in different planes are also possible. Instead of being orthogonal to one another, the display surfaces can be arranged at other non-zero angles with respect to one another for display of content across the surfaces. As shown in FIG. 1, the display surfaces are adjacent one another in an orthogonal orientation. The display surfaces can be adjacent one another by having edges in direct contact, edges connected through one or more other components such as a frame, or edges held next to one another. The display surfaces can be orthogonal by being arranged at 90° to one another or by being arranged close enough to 90° to one another to be perceived by a viewer as being orthogonal.

FIG. 2 is a flow chart of a method 30 for providing changeable electronic content onto orthogonal display surfaces or display surfaces arranged at other non-zero angles. As explained below, method 30 involves optimizing the optics for the system (step 32), optimizing the content for display (step 34), and displaying the optimized projected content (step 36). The steps of method 30 can be performed manually or automatically under software control of processor-based device 25, for example. Also, once the optics are optimized in step 32 for a particular system, the optimization of various types of content for step 34 can be performed automatically under software control of processor-based device 25, for example.

### Optics Optimization

The optics optimization (step 32) can include, for example, the following steps 1-4. These steps 1-4 can be automated to provide real-time, or essentially real-time, data on the optimization of a display system where the parameter to be optimized is viewer observation of display brightness over all display surfaces with minimized stray image reflection at each display surface.

Step 1. The inputs for step 1 are the following: the required number of display surfaces S₁-Sₙ; and a location to fix viewer perspective. When a corner display is being configured, the input requirement includes three orthogonal surfaces S₁-S₃ with the viewer orientation shown in FIG. 1.

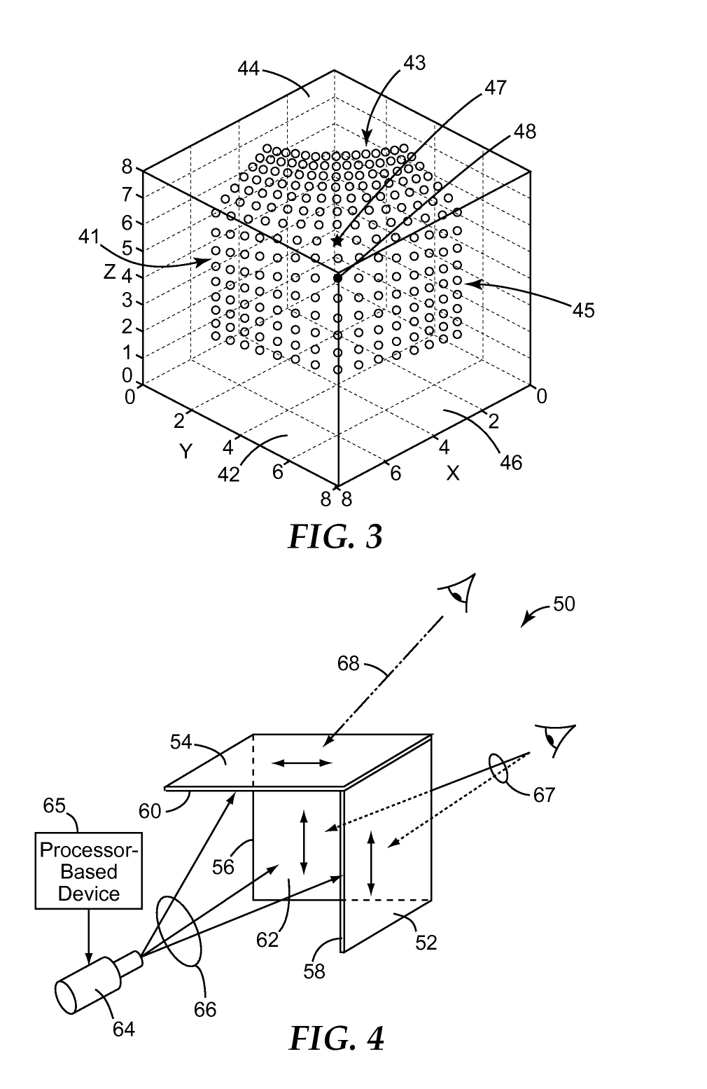

Step 2. This step involves fixing the projector location, projecting onto all display surfaces S₁-Sₙ, and determining the in-focus area for each display surface. This step outputs a matrix of rays for each display surface characterized by spherical coordinates (radius r, azimuth angle Φ, polar angle Θ). Ray tracing methodology can be implemented with the MATLAB program (The MathWorks, Inc.) in the design process to establish the initial display area of each face. The projector can be placed at point Q (0,0,0), representing the position of projector 24, and focused at the corner (point 23) of the display at coordinate P (8,8,8). FIG. 3 is the output diagram showing the intersection of a 15×15 pixel array utilizing a 3M MPro 160 projector. FIG. 3 illustrates ray traces 41, 43, and 45 for display surfaces 42, 44, and 46, respectively, with point 47 representing the projector location (at coordinate (0,0,0) behind the display surfaces) and point 48 representing the viewer position (at coordinate (8,8,8) where the display surfaces meet) along a line from points 47 to 48. Methods to characterize the in-focus rays on each display face S₁-Sₙ, have been described in, for example, the applications identified above.

Step 3. This step involves designing light directing films and characterizing the films by their distinct transmission and reflection ray maps. The inputs for this step include the following: material refractive index; microstructure surface topology; and incoming light direction (Φ, Θ). The outputs for this step includes the following: a light impingement limit for optimum transmission and minimum reflection; and outgoing light direction (Φ, Θ). Ray tracing can be used in the design process to characterize light directing films comprising varied surface topologies. The following describes the characteristics of an image directing film comprising a 60° prismatic surface with collimated light arriving from the prism side. In utilizing this film, the exit light direction should coincide with the fixed viewer perspective as set up in step 2. A similar treatment for characterizing reflected light arriving at the prism surface derives the following condition for maximum transmission and minimized stray light reflection.
50°<Θ<60° and −25°<Φ<25° (+X component)
60°<Θ<80° and 155°<Φ<205° (−X component)

Step 4. This step involves comparing the outputs of steps 2 and 3 in order to test the ability of the image light redirecting film at each display surface. Parameters to be optimized are minimum reflection striking all surfaces S₁-S₃ (for an orthogonal display system). The transmitted light should not only be maximized but work in tandem with the projection screen material. In one mode the projection screen material can be 3M VIKUITI Rear Projection Film (RPF) with optimized light acceptance angle normal to its surface with a deviation of ± 15°. The image light redirecting film is orientated in space so as to meet these requirements. FIG. 1 shows a suggested orientation of the prism direction that is consistent for the viewer direction shown. For the results of the test, if excessive reflected light impinges onto any display surface S₁-Sₙ, or if the transmitted light intensity is too low, then return to step 2 in order to fine-tune the optics.

### Content Optimization

In orthogonal display surfaces, for example the embodiment of FIG. 1, the main distortion to be accounted for is key-stoning. FIG. 3 is a perspective illustrating ray intersection with the display surfaces for the YZ-face (ray trace 41), XZ-face (ray trace 45), and the XY-face (ray trace 43). Using this ray tracing, for example, the content can be predistorted or otherwise converted to appear substantially undistorted on the display surfaces.

FIG. 4 is a diagram of a projection system 50 for providing changeable electronic content onto orthogonal surfaces for a dual view display. System 50 includes display surfaces 52, 54, and 56, each composed of a rear projection screen with light redirecting films 58, 60, and 62, respectively, behind them on a non-viewer side of the display surfaces. The arrows on display surfaces 52, 54, and 56 represent the direction of the prisms in the light redirecting films behind those display surfaces. System 50 includes a projector 64 for projecting changeable electronic content to display surfaces 52, 54 and 56, as represented by lines 66, and a processor-based device 65 for electronically providing content to projector 64. The changeable electronic content can include electronic video content and changeable electronic still images. The electronic content is predistorted or otherwise converted such that, when displayed on display surfaces 52, 54, and 56, the content appears substantially undistorted. For this dual view display, two viewers are shown positioned with one viewer for the X and Y views on display surfaces 52 and 56 as represented by lines 67 and another viewer for the Z view on display surface 54 as represented by line 68.

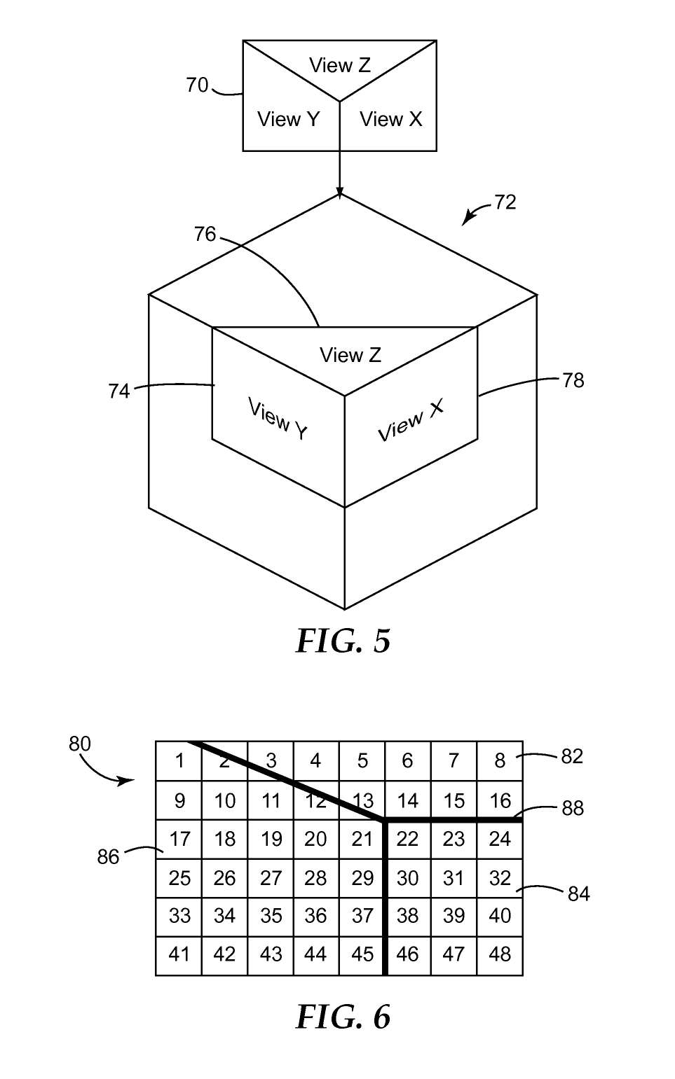

FIG. 5 is a diagram illustrating an example of projecting electronic content onto orthogonal surfaces for the exemplary embodiment of FIG. 1. As illustrated in FIG. 5, a display 72 with orthogonal display surfaces includes displayed content 74, 76, and 78. The original content is represented as a single planar display surface 70, and the Views X, Y, and Z from the original content are predistorted or otherwise converted such that, when displayed on the orthogonal display surfaces, the Views X, Y and Z appear substantially undistorted. The views of the content can be predistorted using, for example, the ray tracing techniques illustrated in FIG. 3. The dual view display of FIG. 4 can also display such views except that Views X and Y are intended for one viewer, and View Z is intended for another viewer based upon the orientation of the light redirecting film on the display surface for the View Z.

Instead of three display surfaces as shown in FIG. 5, a display system can use two display surfaces arranged at a non-zero angle with respect to one another. For example, a system can display Views X and Y as two sides of a product container or housing, or display Views X and Z (or Views Y and Z) as the side and top of the housing.

FIGS. 1 and 4 illustrating projecting directly on the display surfaces. Alternatively, one or more mirrors can be used to reflect content from the projector onto the display surfaces.

### EXAMPLES

Materials

| Abbreviation/ | | |
|---|---|---|
| product name | Description | Available from |
| PLEXIGLAS | Poly(methyl methacrylate) | SABIC |
| MC UF-5 | clear sheeting | POLYMERSHAPES, |
| Acrylic Sheet | | Brooklyn Park, MN |
| MP160 | 30 lumens LCOS projector | 3M Company, St. Paul, |
| | | MN |
| MP410 | 300 lumens LED projector | 3M Company, St. Paul, |
| | with throw ratio 1.5 | MN |
| Kenko SGW-05 | 0.5x wide angle lens | Kenko International, |
| | | Tokyo, Japan |
| VIKUITI XRVS | Beaded rear projection | 3M Company, St. Paul, |
| | film with backside | MN |
| | optically coupling | |
| | adhesive | |
| Photomer 6210 | Aliphatic urethane | Cognis, Monheim, |
| | diacrylate | Germany |
| 1,6-hexane- | Acrylic monomer | Aldrich Chemical |
| dioldiacrylate | | Company, Milwaukee, |
| | | WI |
| LUCIRIN TPO | Photoinitiator | BASF Corporation, |
| | | Florham park NJ |
| MELINEX 454 | 50 micron (2 mil) PET | DuPont Teijin Films, |
| | film having refractive | Hopewell, VA |
| | index about 1.64 | |
| FINAL CUT | Digital editing suite, | Apple Inc., Cupertino, |
| PRO | version 10.0.5 | CA |
| ABODE | Image editing software, | Adobe Systems Inc., |
| PHOTOSHOP | version 12 | San Jose, CA |
| CS5 | | |
| MATLAB | Numerical computing suite, | The MathWorks, Inc., |
| | MATLAB 8, version 2012 | Natick, MA |

### Preparation of Turning Film

A microreplicated tool was prepared as follows. A one dimensional structure (linearly extending prisms with a 50 micron pitch) on a metallic cylindrical tool was made by cutting into the copper surface of the cylindrical tool using a precision diamond turning machine. The resulting copper cylinder with precision prismatic cut features was chrome plated in order to promote release of the cured resin during the microreplicated process.

A UV curable acrylate resin (refractive index ˜1.49) was prepared by mixing 85 parts by weight Photomer 6210, 15 parts by weight 1,6-hexanedioldiacrylate and 1 part by weight LUCIRIN TPO.

Turning film was made by casting the UV curable acrylate resin onto 50 micron (2 mil) MELINEX 454 PET film and curing against the precision patterned cylindrical tool using an LED-based UV curing unit. The resulting turning film contained 60 degree included angle prisms with 50 micron pitch on 50 micron (2 mil) backing. The prisms had no canting and were symmetrical.

### Example 1

### Direct Projection Optimized for Single Viewer

A display box measuring 27 cm (10½ inches) wide×25 cm (10 inches) high×38 cm (15 inches) deep was fabricated from transparent PLEXIGLAS MC UF-5 Acrylic sheeting. An MP160 projector was positioned inside the display box along the box diagonal with the light output directed toward a top corner. Beaded VIKUITI XRVS projection screen pieces were attached on the outer surface of the display box with the beaded side facing inward. With an observer positioned in direct line of sight with the projector (the observer position is hereinafter denoted Viewpoint 1), a piece of prismatic sheeting was rotated while contacting the upper inner face of the display box (microreplicated structures contacting the inner surface; that is pointing away from the projector). The optimum orientation of the turning film, determined as the orientation giving the brightest observed image, had the axes of the prisms of the turning film oriented approximately perpendicular to the viewer as shown in FIG. 1.

Similar rotation of prismatic sheeting on the side surfaces adjacent to the top face showed optimal orientation for both films with the axis of the prisms oriented vertically as shown in FIG. 1.

From the perspective of Viewpoint 1, distinct imagery on all three surfaces of the display box was observed.

### Example 2

### Direct Projection Optimized for Multiple Viewers

Utilizing the display set up of Example 1, the viewer was moved to a position away from the line of sight of the projector (the viewer position is hereinafter denoted Viewpoint 2). A sheet of prismatic turning film was rotated while contacting the upper inner face of the display (microreplicated structures contacting the inner surface; that is pointing away from the projector). The optimum orientation of the prismatic turning film, determined as the orientation giving the brightest image observed, had the axes of the prisms approximately perpendicular to the viewer as shown in FIG. 4. In contrast, from the perspective Viewpoint 1 of Example 1, there was observed a bright image on the vertical surfaces of the display box and a muted image on the top surface.

### Example 3

### Projected Image Reflected from Mirror

A display box with an open back was fabricated from five sheets of 3.2 mm (⅛ inch) thickness acrylic sheeting of dimension 38.7 cm (15¼ inches)×26.7 cm (10½ inches) (top and bottom faces), 37.3 cm (14 11/16 inches) high×26.7 cm (10½ inches) wide (front face), and 36.7 cm (14 7/16 inches) high×38.7 cm (15¼ inches) wide (right and left side faces). The parts were temporarily clamped together for the purpose of determining the projected image size and location.

To increase the projected image size, an MP410 projector fitted with a 0.5× wide angle lens (Kenko SGW-05) was used. The throw distance and hence image size was further increased by bouncing the projected image off a mirror of dimension 30 cm (12 inches)×15 cm (6 inches) attached to the inner surface of the left hand face of the display with double sided adhesive. It was found that projection from the MP410/0.5× lens combination via the mirror reflector resulted in illumination of all three display surfaces. The location of the projected image coincident with the three faces was noted and the corresponding corner of the display comprising a portion of the top face, front face, and right face of the box was cut away for fabrication with a rear projection screen and light directing film. This corner consisted of a rectangular portion of the upper right hand corner of the front face (21.6 cm (8½ inches) wide×18.4 cm (7¼ inches) high), the upper left hand corner of the adjacent side face (18.4 cm (7¼ inches) high×17.1 cm (6¾ inches) wide), and a right-angled trapezoid section from the top face. The base of trapezoid was 21.6 cm (8½ inches) (for aligning with the front face cut-out), and the adjacent right side face of the trapezoid was 17.1 cm (6¾ inches) (for aligning with the right face cut-out). The inner surface of the three cut out pieces were laminated with VIKUITI XRVS Rear Projection film. The entire box was then assembled using a standard hot-melt adhesive. The attachment of the projection screen to the inner surface of the box ensured that the display would not suffer from inadvertent damage due to viewer contact.

The beaded screen on the top and front surface of the display was covered with 60 degree turning film with orientation optimized according to the method described in Example 1. It was observed that light rays hitting the right-face display surface was normal to the beaded screen surface and so required no turning film.

The display box was further fitted with a printed “graphic skin” with printed image relevant to the video image to be projected. The printed graphic skin was cut away to reveal the projected image except for a masking area of about 6 mm (¼ inch) around the edge of the display area.

### Example 4

### Manual Image Optimization

This Example describes the general methodology for manually producing digital or still image content for a multi-surfaced display. For a display of the type described in Example 1a 40×30 gridded JPEG image consistent with the pixel resolution of the MP160 (800×600 pixel) was created using the ABODE PHOTOSHOP CS5 program. This was converted to a suitable video format on a standard digital editing suite (FINAL CUT PRO program). The video was then projected onto the display of Example 1 utilizing a laptop computer as the video player. The boundary edge of each display surface was then noted and marked out onto the original JPEG image. FIG. 6 shows the derived template mask 80 showing the boundary for each video image, in particular a top face image 82, a right face image 84, a left face image 86, and an image boundary 88. Each numbered box in template 80 is divided into a 5×5 grid to produce the 40×30 grid.

The template was imported onto the timeline of a standard digital editing suite as a background image template (FINAL CUT PRO program). The template was then overlaid with three video tracks confining each track to its pre-determined image boundary and maintaining the required video resolution for that tract. Each image was “distorted” to fit within its image boundary with image distorting functionality of the photo editing software. The composite image was then exported from the timeline for viewing in the multi-surfaced display.

To illustrate how the images were “distorted” consider FIG. 6. The right face image 84 of FIG. 6 is a 300×400 pixel image, consistent with the overall 800×600 image requirement. For the left face image 86 of FIG. 6, the 500×600 pixel image is readily “distorted” to fit within its image boundary with image distorting functionality of the photo editing software.

### Example 5

### Automated Optimization

The system of Example 3 was prepared. The “Corner Display Correction Algorithm” described below was implemented in the MATLAB program, and an image was projected into a corner of the display box. The result was an undistorted image displayed on the three surfaces in the corner of the display box.

### Corner Display Correction Algorithm

Step 1: Prompt user to input names of content images to be displayed as well as whether the screen is mirror reversed, if the aspect ratio is to be maintained, and what file type the output image should be saved as (e.g., .bmp).

Step 2: Project mouse (cursor control device) cursor using same projector configuration and settings as to be used to display actual content.

Step 3: Prompt user to use projected mouse cursor to “select” four corners of each of the three surfaces content is to be projected onto.

Step 4: Store the 12 “selected” points (4 corner points for each of three surfaces) as projector “fiducials.”

Step 5: If aspect ratio of the original content is to be maintained, calculate and compare the aspect ratio of the content images and the projected area (determined by the projector “fiducials”). If aspect ratio is different, apply “letterboxing” to content images to maintain final aspect ratio.

Step 6: If projection is mirror reversed (as is common for rear-projection displays), mirror reverse content images using image distortion algorithm.

Step 7: Reference known points in the content (e.g., the four corner points of the image) to the corresponding projector “fiducials” and apply a perspective projective transform to each content image to correct for distortion such as, scaling, shearing, orientation, projective distortion, and location of content.

Step 8: In some cases, distortion of the content image shifts the location of the reference points relative to the projector “fiducials.” In this case, apply a correction to shift the final content location.

Step 9: Display (project) the images in the correct location with all of the appropriate transformations and save an image file for future use as well as the coordinates of the 12 fiducial points.

Table 1 provides sample code for implementing the Corner Display Correction Algorithm in software for execution by a processor such as processor-based device 25.

```
TABLE 1
------------------Corner Display Correction Algorithm-------------------------
The following is a description of the Corner Display Correction Algorithm: Characterize
display and load preferences, select reference fiducial marks, apply image distortion,
display and save distorted image.
In this description, only one image is specified; in the implementation, the code is
expanded to include a total of three images.
------------------Characterize Display and load preferences-------------------
prompt = {‘please enter the name of your first image including the extension. ’,‘please
enter the name of your second image including the extension. ’,‘please enter the name of
your third image including the extension.  ’,‘Do the images appear reversed on the screen
(y/n)? ’,...
‘Would you like to maintain the aspect ratio of the original images (y/n)? ’, ‘please enter
the image type you would like the output saved as (e.g., BMP/JPEG/PNG). ’};
num_lines = 1;
answer = inputdlg(prompt);
inputimage1=char(answer(1));
flipped1=char(answer(4));
aspect1=char(answer(5));
imagetype=char(answer(6));
---------------Select reference fiducial marks------------------------------------
white=WhiteIndex(0);
black=BlackIndex(0);
[wPtr, rect] = Screen(‘OpenWindow’,0, black);
newrect=[ ];
endresults=0;
escapekey=KbName(‘esc’);
enterkey=KbName(‘return’);
ekey=KbName(‘e’);
x=0;
y=0;
pointx=(1:4);
pointy=(1:4);
results=zeros(1);
i=1;
oldType = ShowCursor(‘CrossHair’,wPtr);
Screen(‘TextSize’,wPtr,12);
Screen(‘TextColor’,wPtr,white);
Screen(‘DrawText’,wPtr,(‘If image is normal, select points in clockwise order starting in
the upper left.’),10,100);
Screen(‘DrawText’,wPtr,(‘If image is reversed, select points in counterclockwise
order’),10,124);
Screen(‘DrawText’,wPtr,(‘starting in the upper right.’),10,136);
Screen(‘DrawText’,wPtr,(‘Please press the spacebar to begin.’),10,160);
Screen(‘Flip’,wPtr);
KbWait;
Screen(‘Flip’,wPtr);
while endresults~=1
  keyIsDown = 0;
  while ~keyIsDown;
    [keyIsDown, secs, keyCode] = KbCheck;
  end
  if keyCode(enterkey)
    WaitSecs(.1);
endresults=endresults+1;
elseif keyCode(ekey)
  WaitSecs(.1);
  results=0;
  i=1;
end
while results~=4
[clicks,x,y, whichbutton] = GetClicks(wPtr);
pointx(1,i)=x;
pointy(1,i)=y;
i=i+1;
results=results+1;
end
x1=pointx(1,1);
y1=pointy(1,1);
x2=pointx(1,2);
y2=pointy(1,2);
x3=pointx(1,3);
y3=pointy(1,3);
x4=pointx(1,4);
y4=pointy(1,4);
xx1=pointx(1,1);
yy1=pointy(1,1);
xx2=pointx(1,2);
yy2=pointy(1,2);
xx3=pointx(1,3);
yy3=pointy(1,3);
xx4=pointx(1,4);
yy4=pointy(1,4);
------------------Apply image distortions------------------------------------
-----------------Aspect ratio-----------------------------------------------------
screen_aspect1x=x2−x1;
screen_aspect1y=y4−y1;
screen_ratio1=(screen_aspect1x/screen_aspect1y);
uncorrected1=imread(inputimage1);
sci1=size(uncorrected1);
image_aspect1x=sci1(2);
image_aspect1y=sci1(1);
image_ratio1=(image_aspect1x/image_aspect1y);
if aspect1 == ‘y’
  if image_ratio1 > screen_ratio1
    aspect1y =round((image_aspect1x * screen_aspect1y)/screen_aspect1x);
    margin1=round((aspect1y − sci1(1))/2);
    LBuncorrected1 = zeros(aspect1y,sci1(2),3);
    LBuncorrected1(margin1:(margin1+sci1(1)−1),1:sci1(2),1:3) = uncorrected1(:,:,:);
    uncorrected1 = uint8(LBuncorrected1);
    sci1=size(uncorrected1);
  elseif image_ratio1 < screen_ratio1
    aspect1x = round((image_aspect1y * screen_aspect1x)/screen_aspect1y);
    margin1=round((aspect1x − sci1(2))/2);
    LBuncorrected1 = zeros(sci1(1),aspect1x,3);
    LBuncorrected1(1:sci1(1),margin1:(margin1+sci1(2)−1),1:3) = uncorrected1(:,:,:);
    uncorrected1 = uint8 (LBuncorrected1);
    sci1=size(uncorrected1);
  elseif image_ratio1 == screen_ratio1
  end
end
--------------------------mirror reversed--------------------------------------------
if flipped1 == ‘y’
  uncorrected1(:,:,1)=fliplr(uncorrected1(:,:,1));
  uncorrected1(:,:,2)=fliplr(uncorrected1(:,:,2));
  uncorrected1(:,:,3)=fliplr(uncorrected1(:,:,3));
end
-------------------------geometric distortion------------------------------------------
input_points1=[0 0; (sci1(2)) 0; (sci1(2)) (sci1(1)); 0 (sci1(1))]; %points on input image
NewBox1=[x1 y1; x2 y2; x3 y3; x4 y4]; %points the input points should register to
tform1 = maketform(‘projective’,input_points1,NewBox1);
corrected1 = imtransform(uncorrected1, tform1,‘XY Scale’,1);
-------------------------place image in correct location----------------------------------
refframesize1=(rect(4))*3;
refframesize2=(rect(3))*3;
refframe1=zeros(refframesize1,refframesize2);
sizecor1=size(corrected1);
sizecor1x=sizecor1(2);
sizecor1y=sizecor1(1);
refpoint1=zeros(1,2);
if y1>y2
  refpoint1(2)=y1−y2;
else
  refpoint1(2)=0;
end
if x1>x4
  refpoint1(1)=x1−x4;
else
  refpoint1(1)=0;
end
y1=(rect(4)+y1)-refpoint1(2);
x1=(rect(3)+x1)-refpoint1(1);
refframe1(y1:(y1+sizecor1y)−1,x1:(x1+sizecor1x)−1)=corrected1(:,:,1);
backgroundcrop=[rect(3) rect(4) (rect(3)−1) (rect(4)−1)];
background1=imcrop(refframe1,backgroundcrop);
newimage=zeros(rect(4),rect(3),3);
newimage(:,:,1)=background1;
newimage = uint8(newimage);
--------------------------Display corrected image--------------------------------------
Screen(‘PutImage’, wPtr, newimage);
Screen(‘Flip’,wPtr);
end
Screen(‘closeall’);
-------------------------Write out image----------------------------------------------------
imwrite(newimage, [inputimage1 ‘_correct.’ imagetype],imagetype);
save([inputimage1 ‘_Box1.txt’], ‘Box1’, ‘−ascii’);
```

1. A system for projecting changeable electronic content onto multiple display surfaces, comprising:
a first display surface;
a second display surface; and
a projector located for projecting changeable electronic content to the first and second display surfaces,
wherein the first and second display surfaces are arranged at a non-zero angle with respect to one another,
wherein when the projector receives converted electronic content and projects the converted electronic content to the first and second display surfaces, the first and second display surfaces display the converted electronic content undistorted to a viewer.

2. The system of claim 1, further comprising a third display surface,
wherein the first, second, and third display surfaces are orthogonal with respect to one another,
wherein when the projector receives converted electronic content and projects the converted electronic content to the first, second, and third display surfaces, the first, second, and third display surfaces display the converted electronic content undistorted to a viewer.

3. The system of claim 1, wherein the changeable electronic content comprises electronic video content.

4. The system of claim 1, wherein the changeable electronic content comprises changeable electronic still images.

5. The system of claim 1, wherein the first and second display surfaces have edges adjacent one another.

6. The system of claim 1, wherein the first and second display surfaces have edges in contact with one another.

7. The system of claim 2, wherein each of the first, second, and third display surfaces have edges adjacent edges of two of the other first, second, and third display surfaces.

8. The system of claim 2, wherein each of the first, second, and third display surfaces have edges in contact with edges of two of the other first, second, and third display surfaces.

9. The system of claim 1, wherein each of the first and second display surfaces comprises:
a rear projection screen having a viewer side and a non-viewer side; and
a light redirecting film on the non-viewer side of the rear projection screen.

10. The system of claim 2, wherein each of the first, second, and third display surfaces comprises:
a rear projection screen having a viewer side and a non-viewer side; and
a light redirecting film on the non-viewer side of the rear projection screen.

11. The system of claim 2, wherein the first, second, and third display surfaces comprise a corner of a rectangular shaped housing.

12. The system of claim 2, wherein each of the first, second, and third display surfaces comprise a rear projection screen having a viewer side and a non-viewer side, and at least two of the first, second, and third display surfaces comprise a light redirecting film on the non-viewer side of the rear projection screen.

13. A method for projecting changeable electronic content onto multiple display surfaces, comprising:
providing a plurality of display surfaces arranged at a non-zero angle with respect to one another;
receiving changeable electronic content;
converting the content for display on the plurality display surfaces; and
projecting and displaying the converted content on the plurality of display surfaces such that the converted content appears undistorted to a viewer.

14. The method of claim 13, wherein the providing step includes providing first, second, and third display surfaces arranged orthogonal to one another.

15. The method of claim 13, wherein the receiving step includes receiving electronic video content.

16. The method of claim 13, wherein the receiving step includes receiving electronic still images.

17. The method of claim 13, wherein each of the plurality of display surfaces has an edge adjacent an edge of another one of the plurality of display surfaces.

18. The method of claim 13, wherein each of the plurality of display surfaces has an edge in contact with an edge of another one of the plurality of display surfaces.

19. The method of claim 13, wherein each of the plurality of display surfaces comprises:
a rear projection screen having a viewer side and a non-viewer side; and
a light redirecting film on the non-viewer side of the rear projection screen.

20. The method of claim 14, wherein the providing step includes providing the first, second, and third display surfaces as a corner of a rectangular shaped housing.
